(19) United States
(12) Patent Application Publication
(10) Pub. No.: US 2025/0106688 A1
(43) Pub. Date: Mar. 27, 2025

(54) ACCESS TRAFFIC STEERING, SWITCHING & SPLITTING (ATSSS) EXTENSIONS FOR MULTIPLE ACCESS TYPES AND RATS

(71) Applicant: Cisco Technology, Inc., San Jose, CA (US)

(72) Inventors: Vimal Srivastava, Bangalore (IN); Sri Gundavelli, San Jose, CA (US); Ravi Kiran Guntupalli, Cumming, GA (US)

(21) Appl. No.: 18/475,571

(22) Filed: Sep. 27, 2023

(51) Int. Cl. H04W 28/086; H04W 48/16; H04W 48/20; H04W 60/00; H04W 76/10

(52) U.S. Cl. CPC H04W 28/0861; H04W 48/16; H04W 48/20; H04W 60/00; H04W 76/10

(57) ABSTRACT

In one aspect, a method of supporting enhanced UE policies that control which access technologies and the number of access technologies a user equipment can access beyond a single 3GPP connection and a single non-3GPP connection, the method including registering, by a user equipment, to a 3GPP network, wherein the registering includes an indication that the user equipment supports multi-access packet data unit (MA-PDU) sessions; receiving, by the user equipment, a UE policy for a first application permitting the user equipment to access at least three access technologies for communications while accessing the first application, wherein the UE policy is received from an access mobility function (AMF) of the 3GPP network; and determining, by the user equipment, one or more of the access technologies permitted in the UE policy for the first application to use to establish protocol data unit (PDU) session with the first application.

### BACKGROUND

Multi-access point name (APN) Connectivity (MAPCON) is a technology used in telecommunications and mobile networks that enables seamless handovers and session continuity between different access points in a heterogeneous network environment. In traditional mobile networks, only one access technology was used to connect users. However, with the increasing deployment of small cells, Wi-Fi access points, and other wireless technologies, there is a need to support multiple access points and technologies within a single network. MAPCON addresses this challenge by providing a framework that allows mobile devices to connect and switch between different access points while maintaining a continuous session. This improves the user experience by reducing disruptions during handovers and allows for more efficient and flexible use of available network resources.

Access Traffic Steering, Switching & Splitting (ATSSS) optimizes network utilization across multiple access points. It intelligently and dynamically routes traffic to reduce congestion and increase bandwidth utilization, resulting in improved Quality of Service (Qos) and enhanced customer experiences. The distributed architecture of ATSSS enables high-performance switching and routing capabilities, offering traffic steering, load balancing, and congestion control based on several metrics such as latency, bandwidth utilization, and QoS requirements. ATSSS provides scalability, load balancing across multiple access points, intelligent traffic steering based on QoS requirements, advanced congestion control algorithms, and end-to-end traffic visibility. All of these features are designed to improve the efficiency and reliability of access networks.

### BRIEF DESCRIPTION OF THE DRAWINGS

The present technology will be described with reference to the appended drawings. The drawings aid in the description of the present technology and are not to be considered to be limiting the scope of the appended claims. The accompanying drawings include:

FIG. 1A illustrates an example cloud computing architecture in accordance with some aspects of the disclosed technology;

FIG. 1B illustrates an example fog computing architecture in accordance with some aspects of the disclosed technology;

FIG. 2A depicts an example schematic representation of a 5G network environment in which network slicing has been implemented in accordance with some aspects of the disclosed technology;

FIG. 2B illustrates an example 5G network architecture in accordance with some aspects of the disclosed technology;

FIG. 3 illustrates an example routine for supporting enhanced user equipment (UE) policies that control UE access to access technologies in accordance with some embodiments of the disclosed technology;

FIG. 4 illustrates an example routine for supporting enhanced UE policies that control UE access to access technologies for additional applications in accordance with some embodiments of the disclosed technology;

FIG. 5 shows an example of a computing system 500, which can be, for example any computing device that can implement components of the system in accordance with some aspects of the disclosed technology.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

ATSSS offers the ability to use multiple access types simultaneously, including LTE, new radio (NR), wireless fidelity (Wi-Fi), wireline, low earth orbit satellite (LEO), and geostationary (GEO) satellite. This allows for user traffic to select the best link based on service requirements and QoS type without interruption. Additionally, ATSSS provides enhanced security features by splitting network resources among different users to prevent malicious attacks while optimizing resource utilization and cost savings through efficient load balancing and dynamic bandwidth allocation. By enabling high-performance switching and routing capabilities, ATSSS can optimize various network architectures for improved performance, resulting in a more reliable and secure network. Enhanced services such as seamless handover between multiple access types can improve QoS policies enforcement and dynamic resource usage across different radio technologies, providing faster connection speeds and improved performance without compromising on security or reliability.

The present disclosure enhances user experience by providing an ATSSS solution for the distribution of traffic across different Access/RATs. Further, the present disclosure enables User Equipment (UE) policies for the binding of PDU session with Dedicated Network Name/Slice and other PDU session attributes. To achieve this, the User Equipment Route Selection Policy (URSP) introduces a new element called Access-Rat-Selector. This element specifies the selection and priority of access for Multi-Access (MA)-PDU sessions.

When UE registers with the 5G Core Network (5GC), it indicates its support for ATSSS. In response, the policy control function (PCF) provides the UE with policies containing the rules. Based on these rules, the UE can determine the access types and Radio Access Technologies (RATs) allowed for traffic distribution across multiple Access/RATs. The UE can then select two or three out of the available options, which include LEO, NR, LTE, Wi-Fi, or Wireline.

ATSSS facilitates a distribution of traffic between the different access types to enforce enhanced Quality of Service (QOS) policies, improve security, enable dynamic resource usage across radio technologies, and provide faster connection speeds and improved performance. Ultimately, ATSSS enables organizations to maximize their network investment, which results in greater efficiency, reliability, scalability, and cost savings.

In one aspect, a method of supporting enhanced UE policies that control which access technologies and the number of access technologies a user equipment can access beyond a single 3GPP connection and a single non-3GPP connection, the method includes registering, by a user equipment, to a 3GPP network, where the registering includes an indication that the user equipment supports multi-access packet data unit (MA-PDU) sessions, receiving, by the user equipment, a UE policy for a first application permitting the user equipment to access at least three access technologies for communications while accessing the first application, where the UE policy is received from an access management function (AMF) of the 3GPP network, and determining, by the user equipment, one or more of the access technologies permitted in the UE policy for the first application to use to establish PDU session with the first application.

In another aspect, the method may also include further includes requesting, by the AMF, the UE policy from the PCF after the user equipment requests to register to the 3GPP network.

In another aspect, the method may also include where the AMF retrieves the UE policy from the policy control function (PCF) which stores the UE policy as part of a session management policy.

In another aspect, the method may also include where the UE policy contains an Access-Rat-Selector field, the Access-Rat-Selector field defines the at least three access technologies for communications while accessing the first application, where at least two of the at least three access technologies are non-3GPP connections or 3GPP connections.

In another aspect, the method may also include where the determining the one or more of the access technologies permitted in the UE policy for the first application occurs while starting the application.

In another aspect, the method may also include where the UE policy defines a Max-Access value that designates a maximum number of access technologies that can be in use simultaneously.

In another aspect, the method may also include where the UE policy defines a priority order to influence the user equipment to select a higher priority access technology over a lower priority access technology when both access technologies are available.

In another aspect, the method may also include where the UE policy defines preferred combinations of access technologies to be used together (e.g. LEO+NR, GEO+NR, NR+LTE, LTE+ Untrusted, NR+ Untrusted/Trusted etc.).

In another aspect, the method may also include further includes receiving, by the user equipment, a UE policy for a second application designating permitted access technologies for communications while accessing the second application.

In another aspect, the method may also include further includes receiving, by the user equipment, UE policies for respective additional applications designating permitted access technologies for communications while accessing the respective additional applications, determining, by the user equipment, that greater than a maximum number UE policies are active at the same time, utilizing a default UE policy to access one or more the respective additional applications.

In another aspect, the method may also include further includes receiving, by the user equipment, UE policies for respective additional applications designating permitted access technologies for communications while accessing the respective additional applications, determining, by the user equipment, that greater than a maximum number access technologies are in use at the same time, utilizing a default UE policy to access one or more the respective additional applications.

In another aspect, the method may also include further includes registering, by the user equipment, with the determined one or more of the access technologies permitted in the UE policy for the first application.

In another aspect, the method may also include further includes after the registering with the determined one or more of the access technologies, creating a MA-PDU session with the service management function (SMF), retrieving, by the SMF, the UE policy for the first application from the PCF.

In another aspect, the method may also include where the access technologies include LTE, NR, Wi-Fi, Wire-Line, LEO Satellite and Geo Satellite.

In one aspect, a network device includes one or more memories having computer-readable instructions stored therein. The network device also includes one or more processors configured to execute the computer-readable instructions to register, by a user equipment, to a 3GPP network, where the registering includes an indication that the user equipment supports multi-access packet data unit (MA-PDU) sessions, receive, by the user equipment, a UE policy for a first application permitting the user equipment to access at least three access technologies for communications while accessing the first application, where the UE policy is received from an access mobility function (AMF) of the 3GPP network, and determine, by the user equipment, one or more of the access technologies permitted in the UE policy for the first application to use to establish protocol data unit (PDU) session with the first application.

In one aspect, a non-transitory computer-readable storage medium includes computer-readable instructions, which when executed by one or more processors of a network appliance, cause the network appliance to register, by a user equipment, to a 3GPP network, where the registering includes an indication that the user equipment supports multi-access packet data unit (MA-PDU) sessions, receive, by the user equipment, a UE policy for a first application permitting the user equipment to access at least three access technologies for communications while accessing the first application, where the UE policy is received from an access mobility function (AMF) of the 3GPP network, and determine, by the user equipment, one or more of the access technologies permitted in the UE policy for the first application to use to establish protocol data unit (PDU) session with the first application.

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Oftentimes, ATSSS is implemented across several different access types including but not limited to LTE, NR, Wi-Fi, Wireline, LEO Sat, and Geo Sat. In areas where multiple access types and RATs are available, the UE must choose the most suitable one for the optimal performance of a particular application. In some instances, operators are required to specify two different access types, one for 3GPP connections and one for non-3GPP connections, in the URSP to prioritize multi-access routes within their policy. However, the range of access types operators can choose from has limitations due to operators being unable to restrict the number of access types an application can use, such as only allowing two out of the possible five options (LEO, GEO, LTE, NR, Wireline, and Wi-Fi). Additionally, operators are unable to prioritize available accesses/RATs or establish rules for preferred access combinations, such as LEO+NR, GEO+NR, NR+LTE, LTE+Untrusted, NR+Untrusted/Trusted, and so forth.

To overcome the challenges, this technology aims to improve the deficiencies in various combinations of 3GPP connections and non-3GPP connections. Accordingly, the proposed solution intends to enhance the UE policies provided to the UE, which bind the PDU session with data network name (DNN)/Slice and other attributes of the PDU session. The proposal extends the UE policies to include additional details on selecting access/rat types. Adding a new element related to an access-rat-selector element in the URSP will be used to specify policies related to the selection and priority of access for MA-PDU sessions.

Upon registration with the 5GC, the UE indicates its support for ATSSS. The AMF then obtains the UE Policies with Access-Rat-Selector from PCF and sends it to the UE. When starting an application, the UE can determine the Access/RAT allowed for ATSSS from this Access-Rat-Selector. This selector can indicate the access types/RATs for traffic distribution across multiple Access/RATs based on several rules or UE policies.

In a first example UE policy, a max access of three access technologies selections is indicated. For connections with 3GPP, users can choose from LEO, NR, and LTE, and for non-3GPP connections, Wi-Fi or WireLine can be selected. In this example, the UE can choose at most three out of these five access technologies and prioritize an order of the access technologies selected. In one instance, the UE can execute an instruction where no priority is indicated when using an ‘OR’ operator with the access technology indications. In another instance, the UE can execute an instruction where a priority order is indicated where there is a use of commas in the listing of the access technologies selected.

In a second UE policy example, there is a limit of two access technology selections. For connections related to 3GPP, the available options are LEO, NR, or LTE. For non-3GPP connections, Wi-Fi is the only option. Accordingly, the UE can choose a maximum of two access technologies from the four available.

In a third UE policy example, user equipment devices are limited to selecting a maximum of two access technologies. For connections with 3GPP, users may choose between LEO or Geo, while connections without 3GPP are limited to Wi-Fi only. After registering with an access/RAT based on the UE Policies, the UE will initiate an MA-PDU session and receive the ATSSS Rules from the PCF as part of the session management (SM) Policies.

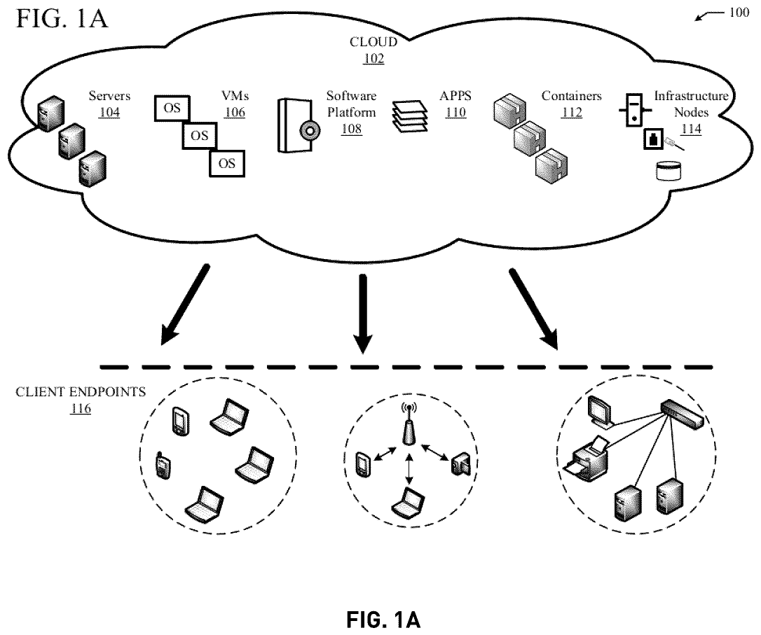

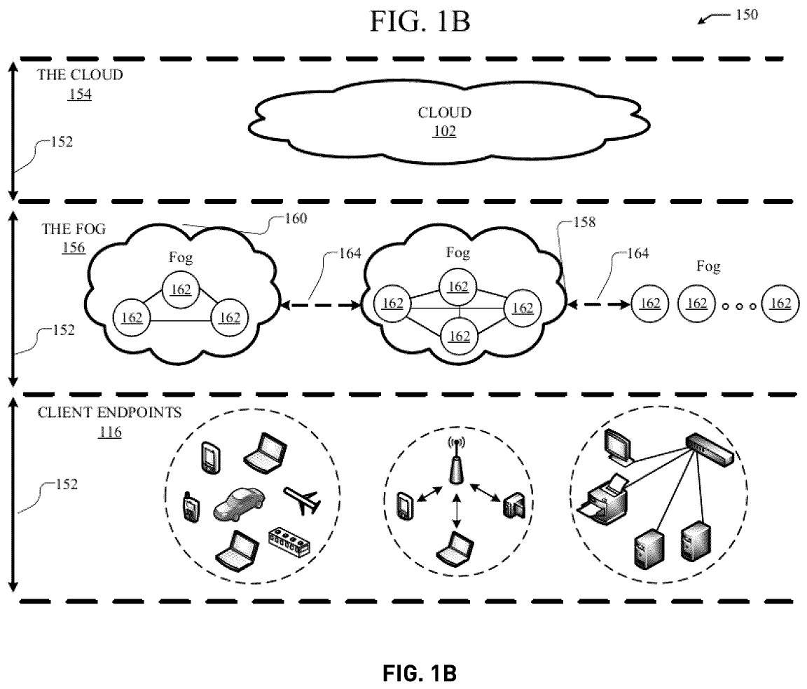

FIG. 1A illustrates a diagram of an example cloud computing architecture 100. The architecture can include a cloud 102. The cloud 102 can be used to form part of a transmission control protocol (TCP) connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a global positioning system (GPS) device, a game system, a smart wearable object (e.g., smartwatch, etc.), a consumer object (e.g., Internet refrigerator, smart lighting system, etc.), a city or transportation system (e.g., traffic control, toll collection system, etc.), an Internet-of-things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture 150 can be incorporated into the cloud computing architecture as described in FIG. 1A. Accordingly, the fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116, as a part of a TCP connection, accessed through the TCP connection, can include an initiator or a receiver of a TCP connection and be utilized by the initiator or the receiver to transmit and/or receive data through the TCP connection.

The fog layer 156 or “the fog” provides the computation, storage, and networking capabilities of traditional cloud networks, but closer to the endpoints. The fog can thus extend the cloud 102 to be closer to the client endpoints 116, and provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc, and be deployed within fog instances 158, 160. For example, the fog instances 156, 158 can be a regional cloud or data center, a local area network, a network of fog nodes 162, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc. Moreover, one or more of the fog nodes 162 can be interconnected with each other via links 164 in various topologies, including star, ring, mesh, or hierarchical arrangements, for example.

In some cases, one or more fog nodes 162 can be mobile fog nodes. The mobile fog nodes can move to different geographic locations, logical locations, or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location.

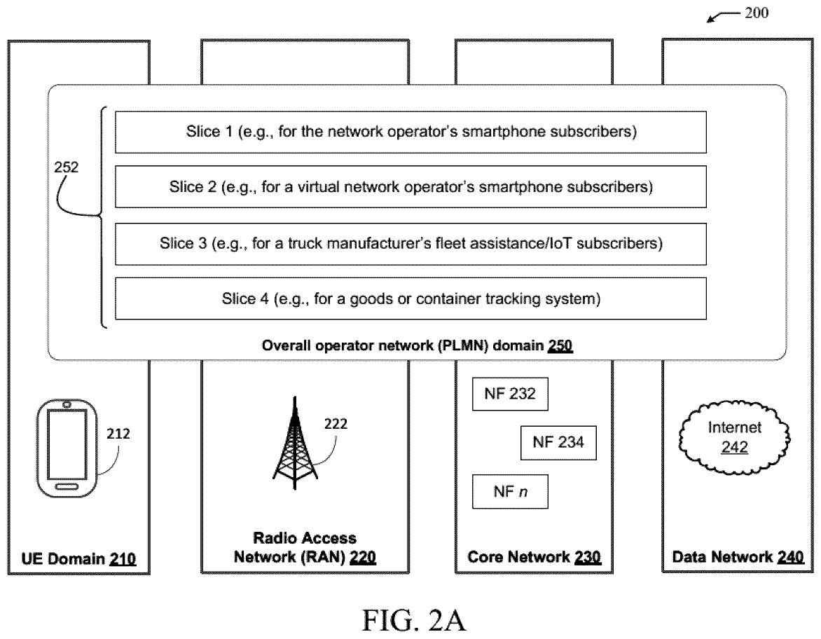

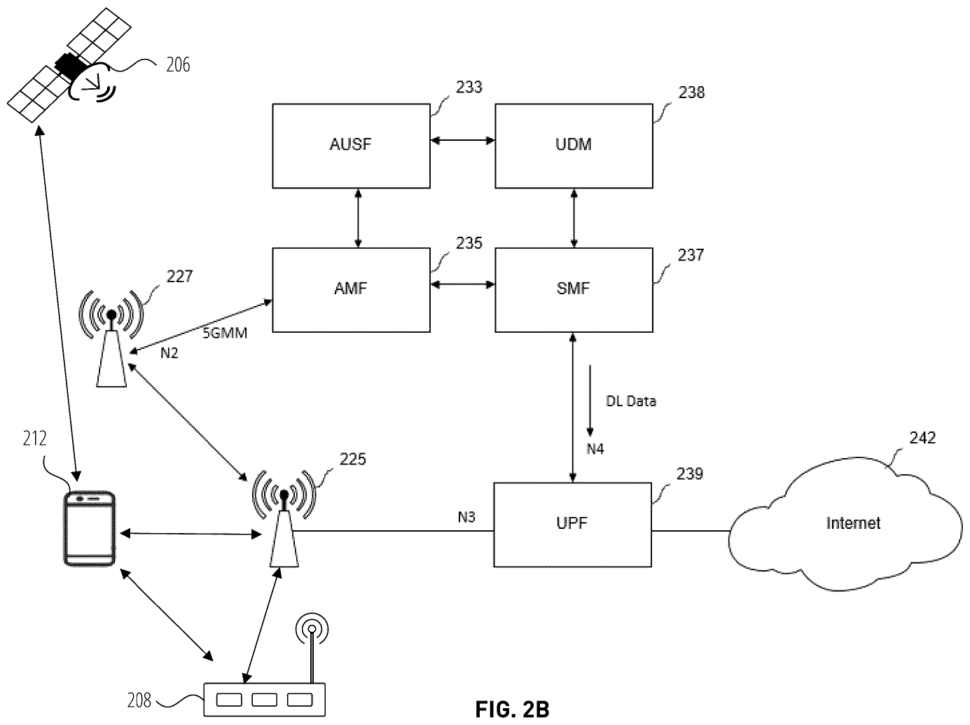

FIG. 2A depicts an exemplary schematic representation of a 5G network environment in which network slicing has been implemented, and in which one or more aspects of the present disclosure may operate, according to some aspects of the present disclosure. In some examples, the 5G network environment 200 can be utilized to implement the cloud 102 of FIG. 1A and/or the fog computing architecture 150 of FIG. 1B.

As illustrated, network environment 200 is divided into four domains, each of which will be explained in greater depth below; a User Equipment (UE) domain 210, e.g. of one or more enterprises, in which a plurality of user cellphones or other connected user equipments 212 reside; a Radio Access Network (RAN) domain 220, in which a plurality of radio cells, base stations, towers, or other radio infrastructure 222 resides; a Core Network 230, in which a plurality of Network Functions (NFs) 232, 234, . . . , n reside; and a Data Network 240, in which one or more data communication networks such as the Internet 242 reside. Additionally, the Data Network 240 can support SaaS providers configured to provide SaaSs to enterprises, e.g. to users in the UE domain 210.

In some example embodiments, core network 230 is a 5G core network (5GC) in accordance with one or more accepted 5GC architectures or designs, or an Evolved Packet Core (EPC) network, which combines aspects of the 5GC with existing 4G networks. Core Network 230 contains a plurality of Network Functions (NFs), shown here as NF 232, NF 234 . . . . NF n, that executes in a control plane of core network 230. The NFs are configured to provide a service-based architecture in which a given NF allows any other authorized NFs to access its services across any of the network slices 252 or as a unique instance. The plurality of NFs of the core network 230 includes one or more of AMF (typically used when core network 230 is a 5GC network); Mobility Management Entities (MME) (typically used when core network 230 is an EPC network); UPFs; PCFs; Authentication Server Functions (AUSFs); UDMs; Application Functions (AFs); Network Exposure Functions (NEFs); NF Repository Functions (NRFs); and Network Slice Selection Functions (NSSFs).

In some example embodiments, an AMF/MME can be common to or otherwise shared by multiple slices of the plurality of network slices 252, and in some example embodiments an AMF/MME can be unique to a single one of the plurality of network slices 252. In some examples, the NFs can include an SMF that controls session establishment, modification, release, etc., and in the course of doing so, provides other NFs with access to these constituent SMF services.

Various other NFs can be provided without departing from the scope of the present disclosure, as would be appreciated by one of ordinary skill in the art.

Across the four domains of the 5G network environment 200, an overall operator network domain 250 is defined. The operator network domain 250 is in some example embodiments a Public Land Mobile Network (PLMN), a private 5G network and/or a 5G enterprise network, and can be thought of as the carrier or business entity that provides cellular service to the end users in UE domain 210. Within the operator network domain 250, a plurality of network slices 252 are created, defined, or otherwise provisioned in order to deliver a desired set of defined features and functionalities, e.g. SaaSs, for a certain use case or corresponding to other requirements or specifications. Note that network slicing for the plurality of network slices 252 is implemented in end-to-end fashion, spanning multiple disparate technical and administrative domains, including management and orchestration planes (not shown). In other words, network slicing is performed from at least the enterprise or subscriber edge at UE domain 210, through the Radio Access Network (RAN) 120, through the 5G access edge and the 5G core network 230, and to the data network 240. Moreover, note that this network slicing may span multiple different 5G providers.

Within the scope of the 5G mobile and wireless network architecture, a network slice comprises a set of defined features and functionalities that together form a complete Public Land Mobile Network (PLMN), a private 5G network and/or a 5G enterprise network for providing services to UEs. This network slicing permits for the controlled composition of the 5G network with the specific network functions and provided services that are required for a specific usage scenario. In other words, network slicing enables a 5G network operator to deploy multiple, independent 5G networks where each is customized by instantiating only those features, capabilities and services required to satisfy a given subset of the UEs or a related business customer needs.

For example, as shown here, the plurality of network slices 252 include Slice 1, which corresponds to smartphone subscribers of the 5G provider who also operates network domain, and Slice 2, which corresponds to smartphone subscribers of a virtual 5G provider leasing capacity from the actual operator of network domain 250. Also shown is Slice 3, which can be provided for a fleet of connected vehicles, and Slice 4, which can be provided for an IoT goods or container tracking system across a factory network or supply chain. Note that these network slices 252 are provided for purposes of illustration, and in accordance with the present disclosure, and the operator network domain 250 can implement any number of network slices as needed, and can implement these network slices for purposes, use cases, or subsets of users and user equipment in addition to those listed above. Specifically, the operator network domain 250 can implement any number of network slices for provisioning SaaSs from SaaS providers to one or more enterprises, to facilitate efficient management of SaaS provisioning to the enterprises.

FIG. 2B illustrates an example 5G network architecture. As addressed above, a User Equipment (UE) 212 can connect to a radio access network provided by a first gNodeB (gNB) 225 or a second gNB 227, as well as a geo satellite 206 or an access point 208.

The gNB 225 can communicate over a control plane N2 interface with an access mobility function (AMF) 235. AMF 235 can handle tasks related to network access through communication with UDM function 238. Collectively AMF 235 and UDM 238 can determine whether a UE should have access and if any parameters related to the access should be applied. Accordingly, AMF 235 utilizes UDM 238 to retrieve any access-based information or restrictions of user equipment 212. AMF 235 also works with AUSF 233 to handle authentication and re-authentication of the user equipment 212 as it moves between access networks. The AUSF and the AMF could be separated or co-located.

Assuming AMF 235 determines the user equipment 212 should have access to a user plane to provide voice or data communications, AMF 235 can select one or more SMFs 237. SMF 237 can configure and control one or more UPFs 239. AUSF 233 can provide a security key to SMF 237 for use in encrypting control plane communications between the SMF 237 and the gNB 225 (or 227) via the UPF. For example, the SMF 237 can configure UPF 239, acting as a router, with traffic classification rules and traffic policies for the internet protocol (IP) address.

As noted above SMF 237 can configure and control one or more user plane functions (UPF) 239. SMF 237 communicates with UPF 239 over an N4 Interface which is a bridge between the control plane and the user plane. SMF 237 can send PDU session management and traffic steering and policy rules to UPF 239 over the N4 interface. UPF 239 can send PDU usage and event reporting to SMF 237 over the N4 interface and also communicate user plane data or voice over the N3 interface back to user equipment 212 through gNB 225.

In one example, the UE can commonly connect to gNodeB 225, access point 208, and Geo Satellite 206 technologies to connect to the internet 242. By connecting to both, a UE is able to extend its reach beyond just one technology, as it can now access wireless areas and locations within a wireless network with gNodeB 225, access point 208, or geo satellite coverage. These multi-access connections can provide the UE with improvements in speed and reliability when managing data traffic transmissions than if it were connected to just one of them.

A User Equipment Route Selection Policy (URSP) is an important tool for managing multiple access technologies. A URSP contains several parameters that allow a user equipment (UE) to make decisions about which access technology to use, when to switch between them and the priority of each connection. The URSP can include information such as the traffic descriptor, which identifies the type of traffic being accessed, the route selector which includes attributes related to route selection and an access RAT selector which specifies policies regarding selection and priority of access for MA-PDU sessions. This allows a UE to manage its connections in order to take advantage of multiple access points and increase coverage area with greater reliability. Furthermore, by making use of a URSP, UEs are able to seamlessly switch between various access technologies in order to provide connections to transmit data traffic between the access technologies.

With the User Equipment Route Selection Policy (URSP) in place, user equipment (UE) can take advantage of multi-access technology. The URSP provides a means for specifying preferences with regard to access types, with each preference containing a traffic descriptor that identifies the type of traffic being accessed. For example, an Apple ID could be used as the traffic descriptor when using WhatsApp. Additionally, the route selector will be included in the URSP which contains attributes related to route selection, such as cost and quality parameters. Lastly, the access RAT selector may also be present in the URSP which allows for policies pertaining to selection and priority of access to MA-PDU sessions to be specified. This makes it possible for UE's to make use of multiple access technologies, thereby increasing their reach and allowing for more reliable connections.

The access-RAT selector is an important tool for defining maximum access for both 3GPP and non-3GPP connections. For example, if the max access is set at three, the 3GPP Connections can comprise of Low Earth Orbit (LEO), New Radio (NR) and Long Term Evolution (LTE). The non-3GPP connections can include Wi-Fi or Wireline. With this configuration, the UE can add a maximum of three out of these five technologies to its connection pool. When using the OR statement in conjunction with the RAT selector, there will not be any priority order; however, when using commas to separate each technology listed in the RAT selector, a priority order will be implemented. In the case of 3GPP, three technologies can be chosen and added to the connection pool; whereas, in the case of non-3GPP connections such as Wi-Fi or WireLine, only one technology can be chosen at a time. This allows for greater flexibility when managing multiple access points.

In another example, the maximum access can be set to two access technologies. The 3GPP Connections can include Low Earth Orbit (LEO), New Radio (NR) or Long Term Evolution (LTE). The non-3GPP connections can comprise of Wi-Fi. With these parameters in place, the user equipment (UE) can add a maximum of two of these four technologies to its connection pool. In addition, if the max access is limited to two connections, then only two 3GPP connections can be chosen and added to the pool; likewise, when selecting from the non-3GPP options, only Wi-Fi is available for use with this configuration.

In another example, the maximum access can be set to three access technologies. The 3GPP Connections can include LEO or Geostationary satellite (GEO), and the non-3GPP connections can comprise of Wi-Fi. With these parameters in place, the user equipment (UE) is able to add a maximum of two out of these three technologies to its connection pool. In addition, if the max access is limited to three connections, then only two 3GPP connections can be chosen and added to the pool; likewise, when selecting from the non-3GPP options, only Wi-Fi is available for use with this configuration. This allows UEs to make informed decisions regarding which technology provides them with the best connection, coverage and speed. Furthermore, by making use of LEO or GEO satellites, UEs are able to extend their coverage area and access more reliable connections across greater distances.

In order for the user equipment 212 to acquire the UE policy that defines the access RAT selector, the user equipment 212 must first register to the 5GC and indicate support of ATSSS. The AMF 235 then obtains the UE Policies with Access-Rat-Selector from PCF and sends it to the user equipment 212. When starting an application, the user equipment 212 can determine the Access/RAT allowed for ATSSS from this Access-Rat-Selector. This selector can indicate the access types/RATs for traffic distribution across multiple Access/RATs based on several rules or UE policies.

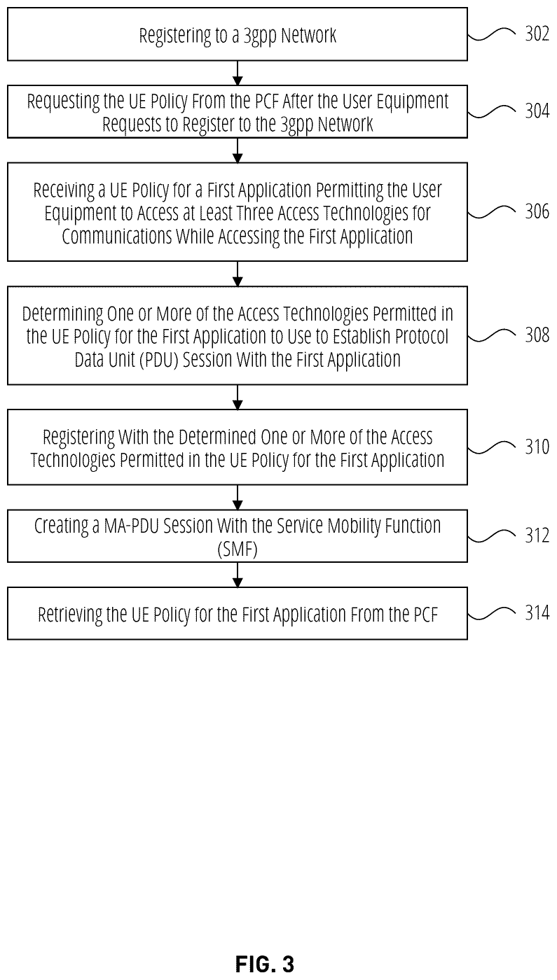

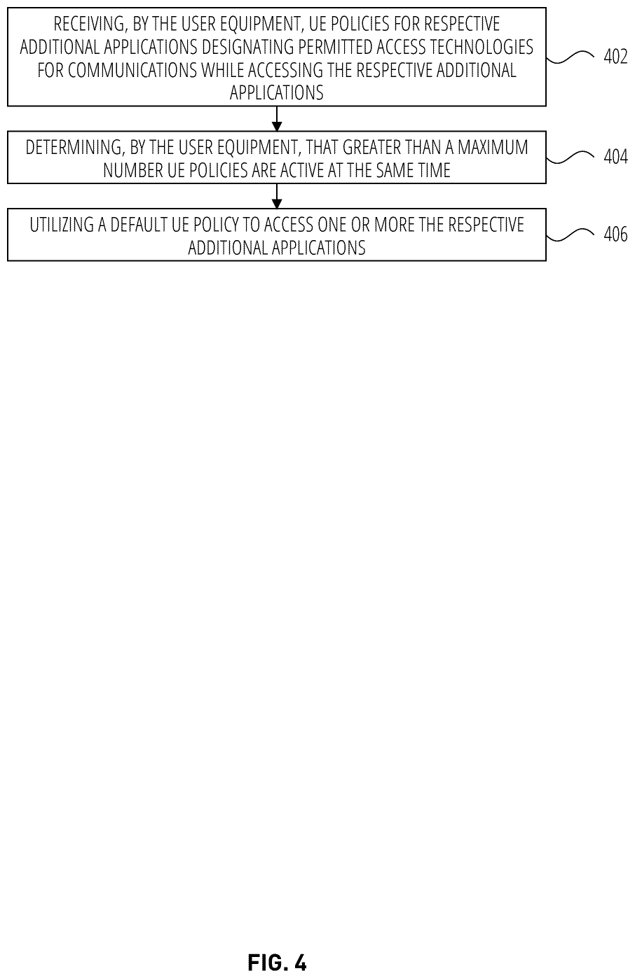

FIG. 3-FIG. 4 illustrates examples of various deployment methods to provide details of a local network, such as a private network hosting a localized service, to a UE. In these examples, the UE may subscribe to an event to obtain access to an event that is hosted by the private network, where the private network is discovered based on the event registration.

FIG. 3 illustrates an example routine for supporting enhanced UE policies that control UE access to access technologies in accordance with some embodiments of the present technology. The example routine in FIG. 3 supports enhanced UE policies that control which access technologies and the number of access technologies a user equipment can access beyond a single 3GPP connection and a single non-3GPP connection. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

ATSSS helps improve the quality of service, security, and resource usage for various types of network access. This results in better performance, faster connection speeds, and cost savings. It is commonly used with LTE, NR, Wi-Fi, Wireline, LEO Sat, and Geo Sat access types. When multiple access types are available, the user equipment must choose the most suitable one for optimal performance. Operators may specify different access types for different connections, but they cannot restrict the number of access types an application can use or prioritize available access types.

To overcome the limitations, the disclosed embodiments enhance the UE policies for both 3GPP and non-3GPP connections by using various combinations of connections. This includes providing additional information on selecting access/rat types through extended UE policies. A new element related to the access-rat-selector element in the URSP is added to specify policies for selecting and prioritizing access for multiple access technologies' MA-PDU sessions.

According to some examples, the method includes registering a UE to a 3GPP network at block 302. For example, user equipment 212 illustrated in FIG. 2B may register to a 3GPP network. Accordingly, the registering includes an indication that the user equipment supports multi-access packet data unit (MA-PDU) sessions.

According to some examples, the method includes requesting a UE policy from the PCF after the user equipment requests to register to the 3GPP network at block 304. For example, the AMF 235 illustrated in FIG. 2B may request the UE policy from the PCF 203 after the user equipment requests to register to the 3GPP network. The AMF 235 retrieves the UE policy from the PCF 203 which stores the UE policy as part of a session management policy.

A UE policy is a set of rules and procedures that define how user equipments 212, as shown in FIG. 2B, connects to, interacts with, and accesses a network. These policies can dictate how the UE will connect to various access points (APs) such as base stations, nodes, gateways or routers. They also specify parameters such as latency, throughput, transfer speed and availability for each AP. The UE policy can ensure that the connection between the user equipment 212 and the related networks is secure, reliable, and efficient. For instance, the UE policy can be used by operators to restrict which technology an application may use or in what order different technologies should be tried when connecting to an AP. Additionally, some policies may provide additional security measures such as encryption protocols or authentication methods.

When it comes to 5G networks, UE policies can establish clear guidelines and standards to guarantee seamless operation and optimal user equipment performance when connected to a wireless network. This is especially important for leveraging technologies such as gNodeB, LEO satellite and GEO satellite access points. By implementing a comprehensive UE policy, operators can maximize quality of service (QOS) policies, improve security, enable dynamic resource usage across radio technologies, and provide faster connection speeds and improved performance.

According to some examples, the method further includes receiving a UE policy for a first application permitting the user equipment to access at least three access technologies for communications while accessing the first application at block 306. Application-specific UE policies can provide the conditions for a successful connection between an application and a network. For instance, some applications may require higher speeds than others or be more sensitive to latency or jitter. In order to address these sensitivities and to facilitate the required higher speeds, a UE policy can specify the parameters necessary to ensure that the connection is optimized for each application. Additionally, in order to leverage 5G networks, UE policies must be able to differentiate between different access types such as LTE, NR, Wi-Fi, Wireline, LEO Sat, and GEO Sat. For example, operators can prioritize one type of access point 208 as shown in FIG. 2B, over another according to their needs and user preference. This ensures that user equipments 212 are provided with optimal performance regardless of which access point they choose.

According to some examples, the method can include retrieving the UE policy for the first application from the PCF. For example, user equipment 212 illustrated in FIG. 2B may retrieve the UE policy from PCF 203. The PCF 203 can construct the UE policy for the subscriber of the user equipment 212 and send it to the user equipment 212. The UE policy can include a traffic descriptor that indicates at least one application the UE policy is associated with and a max access attribute that selects three access technologies selected from LEO, NR, LTE, for 3GPP connections, and Wi-Fi or Wireline for non-3GPP connections.

For example, user equipment 212 illustrated in FIG. 2B may receive a UE policy for a first application permitting the user equipment 212 to access at least three access technologies for communications while accessing the first application. Allowing a user equipment (UE) policy that permits access to at least three different technologies while accessing an application has several benefits. Firstly, it enables user equipments to access the same applications across various networks and client devices without the need to switch networks or client devices when they move. Secondly, it minimizes latency as users do not have to wait for one technology to become available before switching. Finally, it enhances redundancy so that if one connection fails or performs poorly, the user equipment can quickly and easily switch to another connection with better speed and performance.

For example, the UE policy can permit the user equipment 212 to select a combination of at least three technologies from selections including LTE, NR, Wi-Fi, Wire-Line, LEO Satellite, and Geo Satellite. The UE policy is received from AMF 235 of the 3GPP network. The UE policy contains an Access-Rat-Selector field, which can define at least three access technologies for communications while accessing the first application, wherein at least two of the at least three access technologies are non-3GPP connections or 3GPP connections. For example, the UE policy can designate any combination of three access technologies selected from LTE, NR, Wi-Fi, Wire-Line, LEO Satellite, and Geo Satellite.

According to some examples, the method includes determining one or more access technologies permitted in the UE policy for the first application to establish PDU session with the first application at block 308. For example, the user equipment 212 illustrated in FIG. 2B may determine one or more of the access technologies permitted in the UE policy for the first application to use to establish a PDU session with the first application. Determining which of the one or more of the access technologies permitted in the UE policy for the first application occurs while starting the application.

A UE policy can enable a user equipment to access one or more of the permitted access technologies while starting an application. The Max-Access value within the policy will designate how many of these access technologies can be used simultaneously, ensuring that users have access to multiple connections regardless of their location or the type of access they are using. For example, by enhancing the number of access technologies that UEs can access in a wireless network at a given time, the network operator can ensure a more equitable distribution of resources and maintain a consistent level of service for each connected UE.

Additionally, setting a maximum access value in the UE policy can limit the number of UEs that can connect simultaneously and aid in distributing the load evenly across various cells or access points. If a particular cell becomes too congested, the policy can redirect new connection requests to less crowded cells, improving overall network performance. In an example, where the network experiences high traffic or congestion, imposing a max access value can serve as a proactive measure to prevent the network from becoming overwhelmed. This can help maintain stability and prevent service disruptions during peak usage periods.

The UE policy can determine a priority order for the user equipment to choose a higher-priority access technology over a lower-priority one if both are available. This is useful in situations where the UE has access to various types of access technologies such as 3G, 4G LTE, 5G, Wi-Fi, GEO, and LEO. The policy can establish which access technology the user equipment should prefer based on specific criteria. Different access technologies can offer different levels of performance, coverage, and capacity. The network operator can ensure that user equipments are directed to the most suitable technology by defining a priority order which considers their QoS requirements.

For example, a priority order for different access technologies can be defined to optimize network resources. This allows time-sensitive applications such as voice calls to be directed to higher-priority technologies with lower latency while non-real-time data traffic can be assigned to lower-priority technologies. Additionally, load balancing can be achieved by distributing the user equipment's traffic across different access technologies. During peak times or in areas with high congestion, directing some UEs to lower-priority technologies can alleviate the load on higher-priority technologies and prevent network bottlenecks.

In an example, a user device may be establishing a network connection to the internet and considering different access technologies. Each technology has a unique coverage area and signal strength that varies depending on location. To ensure a stable and reliable connection, it's important for the user equipment to prioritize these factors when choosing which access technology to use. Accordingly, the user equipment can give priority to the access technology with the strongest signal or better coverage.

As an example, a UE policy that designates a preferred combination of access technologies for a user's equipment can facilitate intelligent network selection and seamless handover between different technologies. By allowing user equipments to switch effortlessly between various access technologies, preferred combinations ensure that users can maintain connectivity as they move within the network's coverage area. Different access technologies offer unique advantages and disadvantages. By defining preferred combinations, network operators can harness the strengths of each technology to optimize the user equipment's performance. As an example, the policy for user equipment may specify that LTE is available for coverage over a wide area, 5G (NR) is available for high-speed data in crowded urban areas, Wi-Fi is used for faster data rates, and Satellite is utilized when the user equipment is in a remote area with limited connectivity, thereby enhancing network coverage in hard-to-reach or distant locations and improving the overall network reach.

According to some examples, the method includes registering with the determined one or more of the access technologies permitted in the UE policy for the first application at block 310. For example, user equipment 212 illustrated in FIG. 2B may register with the Wi-Fi and Satellite in addition to LTE, for application use, in accordance with the UE policy.

According to some examples, the method includes creating a MA-PDU session with the service mobility function (SMF) at block 312. For example, user equipment 212 illustrated in FIG. 2B may create an MA-PDU session with SMF 237 in accordance with the UE policy.

FIG. 4 illustrates an example routine for supporting enhanced UE policies that control UE access to access technologies for multiple applications in accordance with some embodiments of the disclosed technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

For instance, a smartphone or mobile device can enroll in various access technologies depending on the UE policy or multiple application usage through the user equipment. During initial use, the UE policy may require the user equipment to utilize Wi-Fi, Satellite, and LTE networks for an internet session. In accordance with the UE policy, the user equipment, possessing built-in Wi-Fi capability, scans the surroundings for available Wi-Fi networks. During the scanning, the user equipment discovers a nearby Wi-Fi access point that is part of a public or private Wi-Fi network and successfully authenticates with it. The UE can register with the Wi-Fi access point, permitting the an application in use of the internet session to now use Wi-Fi as its primary access technology.

In an example, when the user equipment is within a given coverage area where multiple access technologies are available, such as cellular, Wi-Fi, low earth orbit (LEO) satellite, and GEO satellite, all of the access technologies are used for data transmission simultaneously. For example, the user equipment can currently have an established internet session, that has a non-guaranteed bit rate (non-GBR). Accordingly, the UE can create an MA-PDU session using both cellular and Wi-Fi access. In support of an ATSSS rule of the UE policy, the data traffic transmitted during the internet session, in accordance with the rule, is transmitted at a 50% capacity over cellular, and a 50% capacity over Wi-Fi.

Furthermore, the distribution of the data traffic can be pursuant to a defined prioritization. The UE policy can designate that data traffic transmitted can be prioritized to be transmitted over a cellular access technology in lieu of Wi-Fi. A preferred order can further be defined where cellular can be prioritized over Wi-Fi, and Wi-Fi over satellite. Therefore, when both Wi-Fi and Cellular are available, the user equipment can adhere to the UE policy can establish a priority for cellular for its higher data rates and lower latency over Wi-Fi. Thus, as the user equipment is in a mobile state during the internet session, the user equipment, in accordance with the UE policy can continuously monitor network conditions. If the Wi-Fi signal becomes weak or is lost, the user equipment automatically switches to the Wi-Fi connection from the cellular connection or the cellular connection to the Wi-Fi connection, maintaining the best available connection for the application in accordance with the preferred priority of the UE policy.

Once the internet session has ended during the user equipment's use of the application, the user equipment can switch to streaming high-definition multimedia. As designated by the UE policy, the preferred order of the access technologies prioritizes cellular over Wi-Fi and Wi-Fi over Satellite. In an example, where the user equipment is now in motion and no longer in a high latency area, the cellular connection can be designated as preferred for streaming due to its higher data rates and lower latency compared to Satellite and Wi-Fi, due to cellular being the prioritized access technology. While in a mobile state, the user equipment can scan and locate an access point offering a Wi-Fi connection to assist with a data transmission. Upon detection of the Wi-Fi connection and authentication, the user equipment can automatically switch from LTE to Wi-Fi as per data transmission prioritization order in the UE policy while performing a simultaneous transmission. Thus, allowing the user equipment to leverage the Wi-Fi network for high-speed streaming, in addition to the cellular data to save on cellular data usage and for more efficient transmitting of a high volume of data.

According to some examples, the method can include receiving, by the user equipment, UE policies for respective additional applications designating permitted access technologies for communications while accessing the respective additional applications at block 402. For example, user equipment 212 illustrated in FIG. 2B may receive the UE policies for the video conferencing application and the multimedia streaming application, representing the first application and the second application respectively. The UE policy designating for each respective application permitted access technologies for communications while user equipment 212 is accessing each of the respective applications.

According to some examples, the method includes determining, by the user equipment, that greater than a maximum number UE policies are active at the same time at block 404. For example, user equipment 212 illustrated in FIG. 2B may determine that the number of UE policies that are active at the same time exceeds a predetermined maximum number of UE policies. It can be determined by the user's equipment that using too many access technologies simultaneously results in exceeding the maximum number of UE policies allowed. This can be the case where the user equipment 212 can only support the use of on UE policy that designates which access access technologies are permitted to transmit data simultaneously. Thus, the user equipment can limit the number of UE policies that are simultaneously active to prevent the UE from overloading itself or the wireless network. In some instances, a UE policy that is registered with the UE can be configured to dynamically adjust the number of allowed connections to access technologies based on network conditions, user equipment preferences, or the UE's capabilities.

According to some examples, the method includes utilizing a default UE policy to access one or more of the respective additional applications at block 406. For example, user equipment 212 illustrated in FIG. 2B may be configured to utilize a default UE policy to access one or more of the respective additional applications. As provided in the above example, the user equipment 212 can utilize the LTE network, as the default access technology, in accordance with the UE policy. Thus, as the user equipment moves into an area with sufficient LTE coverage, the user equipment can seamlessly switches to an LTE connection to provide the best streaming experience.

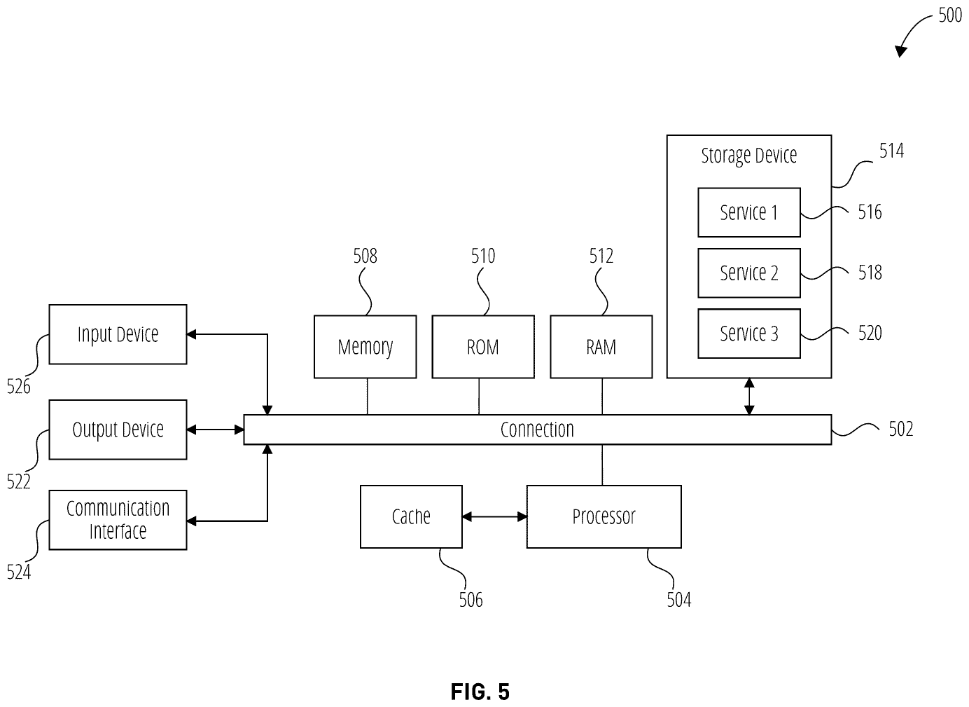

FIG. 5 shows an example of computing system 500, which can be for example any computing device making up client endpoints 116 or virtual machines 106 illustrated in FIG. 1 or user equipment 212 illustrated in FIG. 2B, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., and when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, universal serial bus (USB) devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Some aspects of the present technology include:

Clause 1. A method comprising: registering, by a user equipment, to a 3GPP network, wherein the registering includes an indication that the user equipment supports multi-access packet data unit (MA-PDU) sessions; receiving, by the user equipment, a UE policy for a first application permitting the user equipment to access at least three access technologies for communications while accessing the first application, wherein the UE policy is received from an access mobility function (AMF) of the 3GPP network; and determining, by the user equipment, one or more of the access technologies permitted in the UE policy for the first application to use to establish protocol data unit (PDU) session with the first application.

Clause 2. The method of clause 1, further comprising: requesting, by the AMF, the UE policy from the PCF after the user equipment requests to register to the 3GPP network.

Clause 3. The method of clause 2, wherein the UE policy is retrieved by the AMF from the policy control function (PCF) which stores the UE policy as part of a session management policy.

Clause 4. The method of clause 1, wherein the UE policy contains an Access-Rat-Selector field, the Access-Rat-Selector field defines the at least three access technologies for communications while accessing the first application, wherein at least two of the at least three access technologies are non-3GPP connections or 3GPP connections.

Clause 5. The method of clause 1, wherein the determining the one or more of the access technologies permitted in the UE policy for the first application occurs while starting the application.

Clause 6. The method of clause 1, wherein the UE policy defines a Max-Access value that designates a maximum number of access technologies that can be in use simultaneously.

Clause 7. The method of clause 1, wherein the UE policy defines a priority order to influence the user equipment to select a higher priority access technology over a lower priority access technology when both access technologies are available.

Clause 8. The method of clause 1, wherein the UE policy defines preferred combinations of access technologies to be used together selected from one or more of LEO+NR, GEO+NR. NR+LTE, LTE+ Untrusted, and NR+ Untrusted/Trusted.

Clause 9. The method of clause 1, further comprising: receiving, by the user equipment, a UE policy for a second application designating permitted access technologies for communications while accessing the second application.

Clause 10. The method of clause 1, further comprising: receiving, by the user equipment, UE policies for respective additional applications designating permitted access technologies for communications while accessing the respective additional applications; determining, by the user equipment, that greater than a maximum number UE policies are active at the same time; utilizing a default UE policy to access one or more the respective additional applications.

Clause 11. The method of clause 1, further comprising: receiving, by the user equipment, UE policies for respective additional applications designating permitted access technologies for communications while accessing the respective additional applications; determining, by the user equipment, that greater than a maximum number access technologies are in use at the same time; utilizing a default UE policy to access one or more the respective additional applications.

Clause 12. The method of clause 1, further comprising: registering, by the user equipment, with the determined one or more of the access technologies permitted in the UE policy for the first application.

Clause 13. The method of clause 12, further comprising: after the registering with the determined one or more of the access technologies, creating a MA-PDU session with the service mobility function (SMF); retrieving, by the SMF, the UE policy for the first application from the PCF.

Clause 14. The method of clause 1, wherein the access technologies include LTE, NR. Wi-Fi, Wire-Line, LEO Satellite and Geo Satellite.

Clause 15. A network device comprising: one or more memories having computer-readable instructions stored therein; and one or more processors configured to execute the computer-readable instructions to: register, by a user equipment, to a 3GPP network, wherein the registering includes an indication that the user equipment supports multi-access packet data unit (MA-PDU) sessions; receive, by the user equipment, a UE policy for a first application permitting the user equipment to access at least three access technologies for communications while accessing the first application, wherein the UE policy is received from an access mobility function (AMF) of the 3GPP network; and determine, by the user equipment, one or more of the access technologies permitted in the UE policy for the first application to use to establish protocol data unit (PDU) session with the first application.

Clause 16. A non-transitory computer-readable storage medium comprising computer-readable instructions, which when executed by one or more processors of a network appliance, cause the network appliance to: register, by a user equipment, to a 3GPP network, wherein the registering includes an indication that the user equipment supports multi-access packet data unit (MA-PDU) sessions; receive, by the user equipment, a UE policy for a first application permitting the user equipment to access at least three access technologies for communications while accessing the first application, wherein the UE policy is received from an access mobility function (AMF) of the 3GPP network; and determine, by the user equipment, one or more of the access technologies permitted in the UE policy for the first application to use to establish protocol data unit (PDU) session with the first application.

What is claimed is:

1. A method comprising:
registering, by a user equipment, to a 3GPP network, wherein the registering includes an indication that the user equipment supports multi-access packet data unit (MA-PDU) sessions;
receiving, by the user equipment, a UE policy for a first application permitting the user equipment to access at least three access technologies for communications while accessing the first application, wherein the UE policy is received from an access mobility function (AMF) of the 3GPP network; and
determining, by the user equipment, one or more of the access technologies permitted in the UE policy for the first application to use to establish protocol data unit (PDU) session with the first application.

2. The method of claim 1, wherein the UE policy contains an Access-Rat-Selector field, the Access-Rat-Selector field defines the at least three access technologies for communications while accessing the first application, wherein at least two of the at least three access technologies are non-3GPP connections or 3GPP connections.

3. The method of claim 1, wherein the UE policy defines a Max-Access value that designates a maximum number of access technologies that can be in use simultaneously.

4. The method of claim 1, wherein the UE policy defines a priority order to influence the user equipment to select a higher priority access technology over a lower priority access technology when both access technologies are available.

5. The method of claim 1, further comprising:
receiving, by the user equipment, a UE policy for a second application designating permitted access technologies for communications while accessing the second application.

6. The method of claim 1, further comprising:
receiving, by the user equipment, UE policies for respective additional applications designating permitted access technologies for communications while accessing the respective additional applications;
determining, by the user equipment, that greater than a maximum number UE policies are active at a same time; and
utilizing a default UE policy to access one or more the respective additional applications.

7. The method of claim 1, further comprising:
receiving, by the user equipment, UE policies for respective additional applications designating permitted access technologies for communications while accessing the respective additional applications;
determining, by the user equipment, that greater than a maximum number of access technologies are in use at the same time; and
utilizing a default UE policy to access one or more the respective additional applications.

8. The method of claim 1, further comprising:
registering, by the user equipment, with the determined one or more of the access technologies permitted in the UE policy for the first application;
after the registering with the determined one or more of the access technologies, creating a MA-PDU session with a service mobility function (SMF); and
retrieving, by the SMF, the UE policy for the first application from a policy control function (PCF).

9. A network device comprising:
one or more memories having computer-readable instructions stored therein; and
one or more processors configured to execute the computer-readable instructions to:
register, by a user equipment, to a 3GPP network, wherein the registering includes an indication that the user equipment supports multi-access packet data unit (MA-PDU) sessions;
receive, by the user equipment, a UE policy for a first application permitting the user equipment to access at least three access technologies for communications while accessing the first application, wherein the UE policy is received from an access mobility function (AMF) of the 3GPP network; and
determine, by the user equipment, one or more of the access technologies permitted in the UE policy for the first application to use to establish protocol data unit (PDU) session with the first application.

10. The network device of claim 9, wherein the UE policy contains an Access-Rat-Selector field, the Access-Rat-Selector field defines the at least three access technologies for the communications while accessing the first application, wherein at least two of the at least three access technologies are non-3GPP connections or 3GPP connections.

11. The network device of claim 9, wherein the UE policy defines a Max-Access value that designates a maximum number of access technologies that can be in use simultaneously.

12. The network device of claim 9, wherein the UE policy defines a priority order to influence the user equipment to select a higher priority access technology over a lower priority access technology when both access technologies are available.

13. The network device of claim 9, wherein the one or more processors are further configured to:
receive, by the user equipment, a UE policy for a second application designating permitted access technologies for communications while accessing the second application.

14. The network device of claim 9, wherein the one or more processors are further configured to:
receive, by the user equipment, UE policies for respective additional applications designating permitted access technologies for communications while accessing the respective additional applications;
determine, by the user equipment, that greater than a maximum number UE policies are active at a same time; and
utilize a default UE policy to access one or more the respective additional applications.

15. The network device of claim 9, wherein the one or more processors are further configured to:
receive, by the user equipment, UE policies for respective additional applications designating permitted access technologies for communications while accessing the respective additional applications;
determine, by the user equipment, that greater than a maximum number access technologies are in use at the same time; and
utilize a default UE policy to access one or more the respective additional applications.

16. The network device of claim 9, wherein the one or more processors are further configured to:
register, by the user equipment, with the determined one or more of the access technologies permitted in the UE policy for the first application;
after the registering with the determined one or more of the access technologies, create a MA-PDU session with a service mobility function (SMF); and
retrieve, by the SMF, the UE policy for the first application from a policy control function (PCF).

17. A non-transitory computer-readable storage medium comprising computer-readable instructions, which when executed by one or more processors of a network appliance, cause the network appliance to:
register, by a user equipment, to a 3GPP network, wherein the registering includes an indication that the user equipment supports multi-access packet data unit (MA-PDU) sessions;
receive, by the user equipment, a UE policy for a first application permitting the user equipment to access at least three access technologies for communications while accessing the first application, wherein the UE policy is received from an access mobility function (AMF) of the 3GPP network; and
determine, by the user equipment, one or more of the access technologies permitted in the UE policy for the first application to use to establish protocol data unit (PDU) session with the first application.

18. The non-transitory computer-readable storage medium of claim 17, wherein the UE policy contains an Access-Rat-Selector field, the Access-Rat-Selector field defines the at least three access technologies for the communications while access the first application, wherein at least two of the at least three access technologies are non-3GPP connections or 3GPP connections.

19. The computer-readable storage medium of claim 17, wherein the UE policy defines a Max-Access value that designates a maximum number of access technologies that can be in use simultaneously.

20. The computer-readable storage medium of claim 17, wherein the UE policy defines a priority order to influence the user equipment to select a higher priority access technology over a lower priority access technology when both access technologies are available.
